(19) United States
(12) Patent Application Publication
(10) Pub. No.: US 2026/0249601 A1
(43) Pub. Date: Aug. 27, 2026

(54) PACKAGING BOX FOR ASSISTING IN APPLICATION OF TEMPERED GLASS SCREEN PROTECTOR FOR MOBILE PHONE

(71) Applicant: DONGGUAN OUHUI PACKAGING PRODUCTS CO., LTD., DONGGUAN (CN)

(72) Inventor: LILIN HU, DONGGUAN (CN)

(21) Appl. No.: 19/090,421

(22) Filed: Mar. 26, 2025

(30) Foreign Application Priority Data
Feb. 26, 2025 (CN) 202520314506.3

(51) Int. Cl. B32B 37/00; B32B 37/10; B32B 38/18

(52) U.S. Cl. CPC B32B 37/0046; B32B 37/10; B32B 38/18; B32B 2457/20

(57) ABSTRACT

A packaging box for assisting in application of a tempered glass screen protector for a mobile phone, including: a first base plate; where a positioning seat is arranged on the first base plate, and a profiling cavity is defined on the positioning seat; a side of the first base plate is arranged with a side cover that is flippable; an outer side of the side cover and the first base plate is sleeved with a side envelope.

### TECHNICAL FIELD

The present disclosure relates to the technical field of film application for mobile phones, and in particular to a packaging box for assisting in application of a tempered glass screen protector for a mobile phone.

### BACKGROUND

In the contemporary digital era, mobile phones have become indispensable components of daily life. To safeguard screens against abrasions, wear, and fractures, tempered glass screen protectors have gained widespread adoption as effective protective solutions. However, the application process of these protectors often poses significant challenges for users.

A conventional packaging box for tempered glass screen protectors (also referred to “film”) merely serves the utilitarian purpose of containment and protection, offering no substantive assistance during the application phase. Users frequently encounter multiple issues when attempting self-application. Firstly, achieving precise alignment between the screen and the protector is notoriously difficult, often resulting in misalignment that not only compromises aesthetics but also leaves screen edges inadequately protected. Secondly, the process is highly susceptible to air bubbles, necessitating additional time and effort to rectify; improper handling may further degrade visual clarity and touch sensitivity. Moreover, in an environment where the film-application conditions are not ideal, such as elevated dust levels, the dust will easily adhere to the screen or tempered glass screen protector, resulting in a noticeable graininess after the protector is applied, which reduces the clarity and display effect of the screen. Once the protector is applied in the above-mentioned undesirable conditions, users often need to re-purchase a tempered glass screen protector to try again, which undoubtedly increases the user's cost of use.

### SUMMARY OF THE DISCLOSURE

In view of the deficiencies of the related art, the purpose of the present disclosure is to provide a packaging box for assisting in application of a tempered glass screen protector for a mobile phone.

The purpose of the present disclosure may be achieved by the technical solution described below: A packaging box for assisting in application of a tempered glass screen protector for a mobile phone, including: a first base plate; wherein a positioning seat is arranged on the first base plate, and a profiling cavity is defined on the positioning seat; a side of the first base plate is arranged with a side cover that is flippable; an outer side of the side cover and the first base plate is sleeved with a side envelope.

In some embodiments, a side wall of the profiling cavity defines a first clearance.

In some embodiments, a first groove is defined on the positioning seat on an end of the profiling cavity, and a second groove is defined on the positioning seat on an opposite end of the cavity; a positioning block is arranged on the first groove, and a side of the positioning block is arranged with an adhesive sheet.

In some embodiments, each of two symmetrical inner walls of the profiling cavity is arranged with a step, and a second clearance is defined on an end of the step close to the positioning block.

In some embodiments, a limiting slot is defined on the step.

In some embodiments, the side envelope includes a second base plate, and each of two opposite ends of the second base plate is arranged with a first side plate that is foldable; a side of the second base plate is arranged with a second side plate that is foldable; a side of the first side plate is arranged with a wing plate that is foldable; a slot is defined between the first side plate and the wing plate; a side of the second side plate is arranged with a cover plate that is foldable, and each of two opposite ends of the cover plate is arranged with a plug-in tab configured to match with the slot.

In some embodiments, the side envelope includes a second base plate, and each of two opposite ends of the second base plate is arranged with a first side plate that is foldable; a side of the second base plate is arranged with a second side plate that is foldable; an opposite side of the second base plate is arranged with a third side plate; a side of the first side plate is arranged with a wing plate that is foldable; a side of the third side plate is arranged with a first outer wing plate; a slot is defined between the first side plate and the wing plate; a side of the second side plate is connected to a cover plate that is foldable; each of two opposite ends of the cover plate is arranged with a plug-in tab configured to match with the slot; a side of the cover plate is arranged with a fourth side plate that is foldable, and a side of the fourth side plate is arranged with a second outer wing plate that is foldable.

In some embodiments, a cutout is defined on each of the second base plate and the cover plate.

In some embodiments, a pressure block is arranged in the middle of the side cover; or, an opening is defined on the side cover.

In some embodiments, a positioning slot is vertically defined in the profiling cavity, and a heightening strip is arranged in the positioning slot.

In some embodiments, a notch is defined on the positioning seat on each of both opposite sides of the profiling cavity.

In some embodiments, an end of the positioning seat defines a second groove, and an opposite end of the positioning seat is arranged with a positioning block; a lifting portion is arranged around a periphery of the positioning block.

### BRIEF DESCRIPTION OF THE DRAWINGS

The accompanying drawings are intended to further illustrate the present disclosure, but the embodiments in the accompanying drawings do not constitute any restrictions on the present disclosure. For those skilled in in the art, without having to pay for creative work, other drawings may be obtained based on the following drawings.

FIG. 1 is a structural schematic view of a packaging box for assisting in application of a tempered glass screen protector for a mobile phone according to a first embodiment of the present disclosure.

FIG. 2 is a structural schematic view of a packaging box for assisting in application of a tempered glass screen protector for a mobile phone according to a second embodiment of the present disclosure.

FIG. 3 is a structural schematic view of a side envelope of the packaging box according to the first embodiment of the present disclosure.

FIG. 4 is a structural schematic view of a side envelope of the packaging box according to the second embodiment of the present disclosure.

FIG. 5 is a structural schematic view of a tempered glass screen protector according to a first embodiment of the present disclosure.

FIG. 6 is a structural schematic view of a tempered glass screen protector according to a second embodiment of the present disclosure.

FIG. 7 is a structural schematic view of a packaging box for assisting in application of a tempered glass screen protector for a mobile phone according to a third embodiment of the present disclosure.

FIG. 8 is a structural schematic view of a packaging box for assisting in application of a tempered glass screen protector for a mobile phone according to a fourth embodiment of the present disclosure.

FIG. 9 is a front view of a positioning seat according to some embodiments of the present disclosure.

FIG. 10 is a side view of a positioning seat according to some embodiments of the present disclosure.

FIG. 11 is a structural schematic view of a packaging box for assisting in application of a tempered glass screen protector for a mobile phone according to a fifth embodiment of the present disclosure.

Reference numerals: 1, positioning seat; 2, profiling cavity; 3, first clearance; 4, positioning block; 401, lifting portion; 5, first groove; 6, first base plate; 7, side cover; 701, opening; 8, side envelope; 801, second base plate; 802, first side plate; 803, second side plate; 804, wing plate; 805, slot; 806, cover plate; 807, plug-in tab; 808, cutout; 809, third side plate; 810, first outer wing plate; 811, fourth side plate; 812, second outer wing plate; 9, pressure block; 10, positioning slot; 11, heightening strip; 12, notch; 13, step; 14, tempered glass screen protector; 15, protective film; 16, positioning hole; 17, release film; 18, puling strip; 19, limiting slot; 20, adhesive sheet; 21, limiting protrusion; 22, dashed line; 23, second clearance; 24, second groove.

### DETAILED DESCRIPTION

It should be noted that when the embodiments of the present disclosure involve directional indications (such as up, down, left, right, front, back, etc.), the directional indications are only intended to explain a relative positional relationship between various components and a movement situation in a particular posture (as shown in the accompanying drawings). When this posture changes, the directional indications may change accordingly.

In addition, when the embodiments of the present disclosure involve descriptions such as “first” and “second”, such descriptions are for descriptive purposes only and should not be construed as indicating or implying their relative importance or implying a specified number of technical features. Thus, features that are limited with “first” or “second” may expressly or impliedly include at least one of such features. In addition, the technical solutions of the various embodiments may be combined with each other, but only on the basis that they can be realized by those skilled in the art. When the combination of technical solutions is contradictory or unfeasible, such combination of technical solutions shall be deemed to be non-existent and shall not be within the scope of the present disclosure.

The technical solution of the present disclosure will be described clearly and completely with specific embodiments below. Obviously, the embodiments described are only some embodiments of the present disclosure, not all of them. Based on the embodiments of the present disclosure, all other embodiments obtained by those skilled in the art without creative work belong to the scope of the present disclosure.

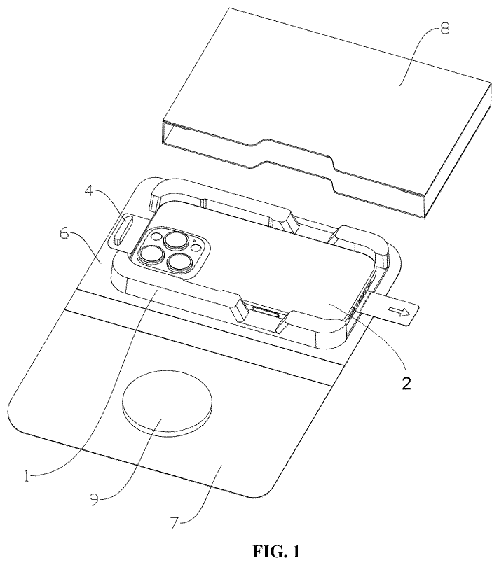

As shown in FIGS. 1 to 4, the present disclosure provides a packaging box for assisting in application of a tempered glass screen protector for a mobile phone, including: a first base plate 6; a positioning seat 1, arranged on the first base plate 6 and integrally formed by a blister mold to ensure structural stability and precision; and a profiling cavity 2, defined on the positioning seat 1, where the tempered glass screen protector 14 is configured to be arranged in the profiling cavity 2; a profiling of the profiling cavity 2 matches a profiling of the mobile phone, thereby while accommodating and protecting the tempered glass screen protector 14, accurately positioning the tempered glass screen protector 14 and the mobile phone to ensure the accuracy of film application. A side of the first base plate 6 is arranged with a side cover 7 that is flippable, and two indentations are arranged between the side cover 7 and the first base plate 6, such that the side cover 7 can be flipped along the two indentations. A spacing between the two indentations is equal to a height of the positioning seat 1, such that the side cover 7 can be flipped to be parallel to the positioning seat 1. An outer side of the side cover 7 and the first base plate 6 is sleeved with a side envelope 8, and the positioning seat 1 is configured to be sealed by the side envelope 8 after the side cover 7 is flipped to cover the positioning seat 1, thereby forming a complete box to protect the tempered glass screen protector 14 in the profiling cavity 2 from external contamination or damage.

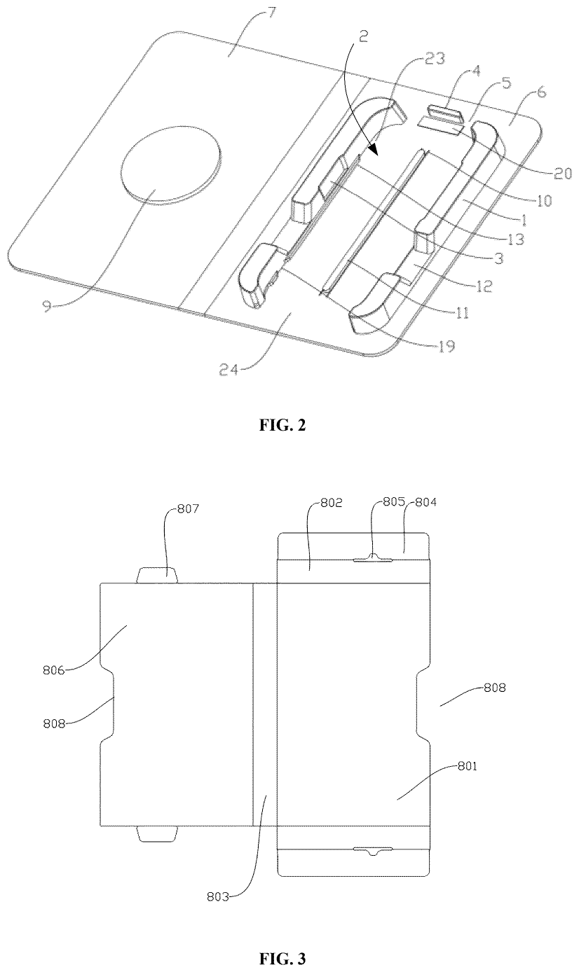

As shown in FIG. 2, a side wall of the profiling cavity 2 defines a first clearance 3 to accommodate a button on a side of the mobile phone.

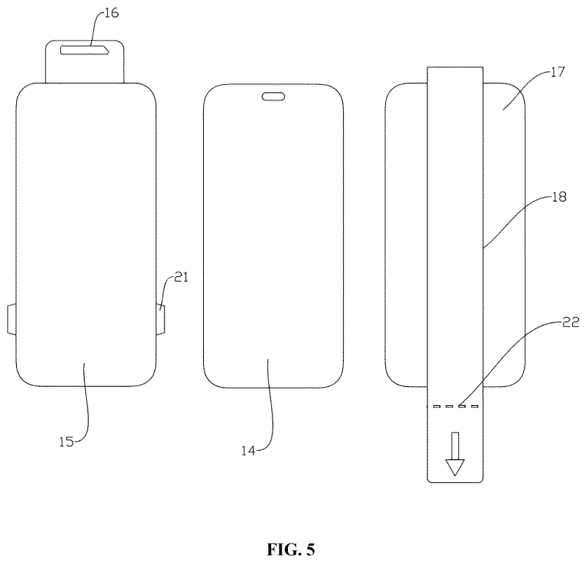

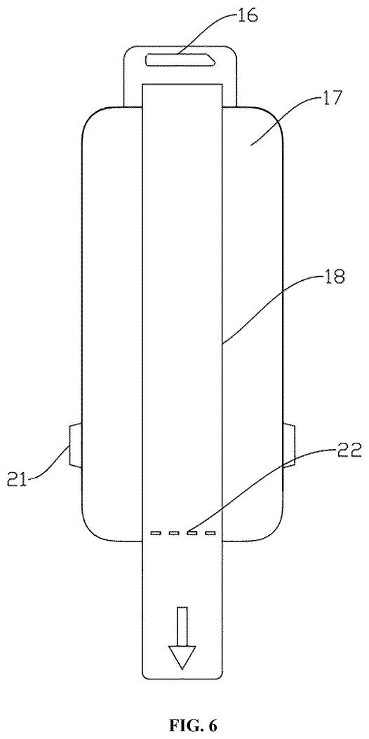

As shown in FIGS. 2, 5, and 6, a first groove 5 is defined on the positioning seat 1 on an end of the profiling cavity 2, and a second groove 24 is defined on the positioning seat 1 on an opposite end of the cavity 2. A positioning block 4 is arranged on the first groove 5, and a protective film 15 is arranged on an outer surface of the tempered glass screen protector 14. An end of the protective film 15 defines a positioning hole 16 configured to match with the positioning block 4, where the positioning hole 16 is configured to be sleeved on the positioning block 4, thereby fixing the tempered glass screen protector 14 in the profiling cavity 2. The positioning block 4 is configured with a foolproof design with asymmetric ends to prevent the tempered glass screen protector 14 from being mounted upside down. A side of the positioning block 4 is arranged with an adhesive sheet 20, which firmly adheres an end of the protective film 15 to prevent the positioning hole 16 from detaching from the positioning block 4 and affecting the positioning of the tempered glass screen protector 14. A bonding surface of the tempered glass screen protector 14 is arranged with a release film 17; where the release film 17 is arranged with a puling strip 18, an end of the puling strip 18 being fixedly connected to an end of the release film 17 close to the positioning block 4, and another end of the puling strip 18 extending to the second groove 24 and being arranged with a dashed line 22; the puling strip 18 is foldable along the dashed line 22, and the release film 17 is configured to be withdrawn through the second groove 24 during film application.

As shown in FIGS. 2, 5, and 6, each of two symmetrical inner walls of the profiling cavity 2 is arranged with a step 13. The mobile phone is configured to be clipped on the step 13, and the tempered glass screen protector 14 is disposed under the step 13, such that a certain gap is left between a display screen of the mobile phone and the tempered glass screen protector 14, which facilitates the extraction of the release film 17. A second clearance 23 is defined on an end of the step 13 close to the positioning block 4, and the second clearance 23 is configured to leave a certain gap for the tempered glass screen protector 14, to avoid the tempered glass screen protector 14 from being stuck on the step 13, which would result in inaccurate positioning during film application.

As shown in FIGS. 2, 5 and 6, a limiting slot 19 is defined on the step 13, and a limit projection 21 configured to match with the limiting slot 19 is arranged on the protective film 15, so as to further position the tempered glass screen protector 14 and prevent the tempered glass screen protector 14 from moving left and right, which would affect the positioning.

As shown in FIG. 3, the side envelope 8 includes a second base plate 801, and each of two opposite ends of the second base plate 801 is arranged with a first side plate 802 that is foldable. A side of the second base plate 801 is arranged with a second side plate 803 that is foldable. A side of the first side plate 802 is arranged with a wing plate 804 that is foldable. A slot 805 is defined between the first side plate 802 and the wing plate 804. A side of the second side plate 803 is arranged with a cover plate 806 that is foldable, and each of two opposite ends of the cover plate 806 is arranged with a plug-in tab 807 configured to match with the slot 805. Specifically, the side envelope 8 is fully unfolded during transportation or storage to save space. When the side envelope 8 is in use, the first side plate 802 and the second side plate 803 are folded upward, the wing plate 804 is folded toward the center, the cover plate 806 is folded toward the second base plate 801, and the plug-in tab 807 is inserted into the slot 805 to catch it, thereby achieving a quick assembly.

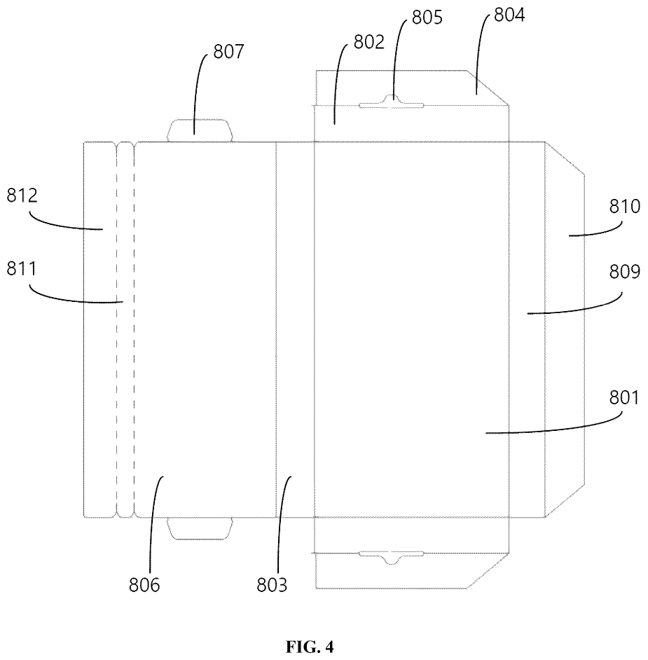

As shown in FIG. 4, the side envelope 8 includes a second base plate 801, and each of two opposite ends of the second base plate 801 is arranged with a first side plate 802 that is foldable. A side of the second base plate 801 is arranged with a second side plate 803 that is foldable. An opposite side of the second base plate 801 is arranged with a third side plate 809. A side of the first side plate 802 is arranged with a wing plate 804 that is foldable. A side of the third side plate 809 is arranged with a first outer wing plate 810. A slot 805 is defined between the first side plate 802 and the wing plate 804. A side of the second side plate 803 is connected to a cover plate 806 that is foldable. Each of two opposite ends of the cover plate 806 is arranged with a plug-in tab 807 configured to match with the slot 805. A side of the cover plate 806 is arranged with a fourth side plate 811 that is foldable, and a side of the fourth side plate 811 is arranged with a second outer wing plate 812 that is foldable.

As shown in FIG. 3, a cutout 808 is defined on each of the second base plate 801 and the cover plate 806, and the cutout 808 serves as an opening position after the second base plate 801 and the cover plate 806 are assembled, so as to facilitate the removal of the tempered glass screen protector 14.

As shown in FIGS. 1 and 2, a pressure block 9 is arranged in the middle of the side cover 7 to eliminate a height difference between a camera on the back of the mobile phone and the side cover 7. During film application, the side cover 7 is flipped to cover the positioning seat 1 and a certain pressure is applied to the mobile phone to press it against the profiling cavity 2 through the pressure block 9, thereby preventing the mobile phone from moving during the film application. The pressure block 9 may be made of foam material to avoid scratching the back cover of the mobile phone.

As shown in FIG. 2, a positioning slot 10 is vertically defined in the profiling cavity 2, and a heightening strip 11 is arranged in the positioning slot 10. The positioning slot 10 is configured to position the heightening strip 11, ensuring that the heightening strip 11 is in the middle of the profiling cavity 2 during the application process. The heightening strip 11 is configured to cause an end of the tempered glass screen protector 14 to be higher than another end. After the release film 17 on the tempered glass screen protector 14 is completely removed, the tempered glass screen protector 14 begins to slowly adhere from the center to both sides, which helps to expel the air between the screen and the tempered glass screen protector 14 and prevent the formation of bubbles.

As shown in FIG. 2, a notch 12 is defined on the positioning seat 1 on each of both opposite sides of the profiling cavity 2 to facilitate the placement and removal of the mobile phone.

For specific use, as shown in FIG. 1, the positioning seat 1 is removed from the side envelope 8, the side cover 7 is opened, the display screen of the mobile phone is placed facing the tempered glass screen protector 14 into the profiling cavity 2, the side cover 7 is closed, a certain amount of pressure is applied, and the puling strip 18 is pulled outward to drive the release film 17 to flip up, such that a contact surface of the release film 17 abuts against the display screen. As the puling strip 18 continues to be pulled outward, the release film 17 is separated from the tempered glass screen protector 14 while picking up the dust on the display screen, until the release film 17 has completely peeled away from the tempered glass screen protector 14 and the display screen is completely applied to the tempered glass screen protector 14. The mobile phone is then removed from the profiling cavity 2 and the protective film 15 is peeled off.

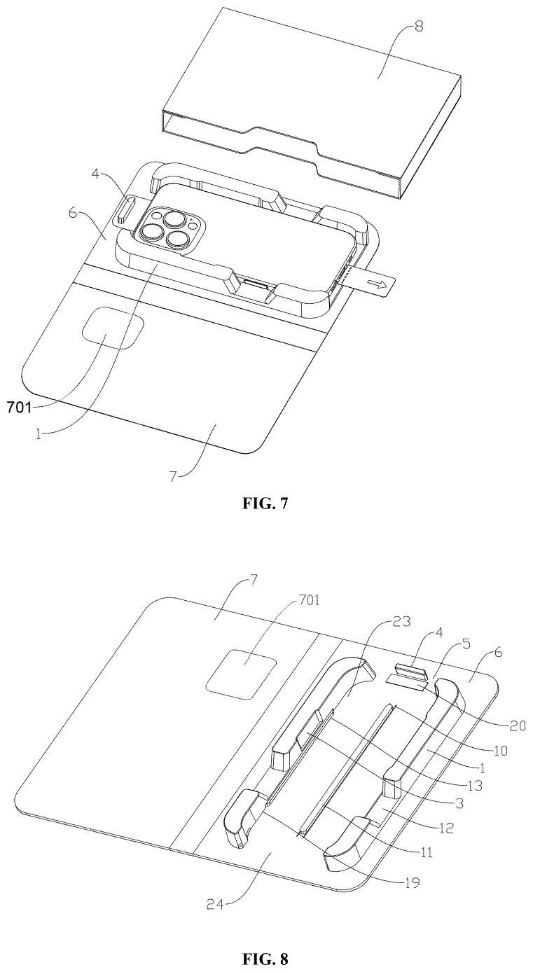

The embodiments shown in FIGS. 7-8, respectively, as compared to the embodiment shown in FIGS. 1-2, differ in that the pressure block 9 on the side cover 7 may be replaced with an opening 701, the position of which is set facing the position of a camera of the mobile phone, and the opening 701 may be slightly larger than the camera. The opening 701 is configured to avoid the position of the camera when the side cover 7 covers the mobile phone.

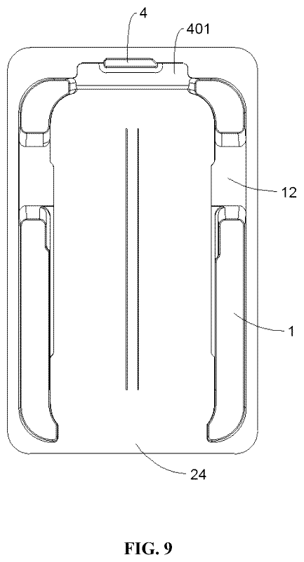

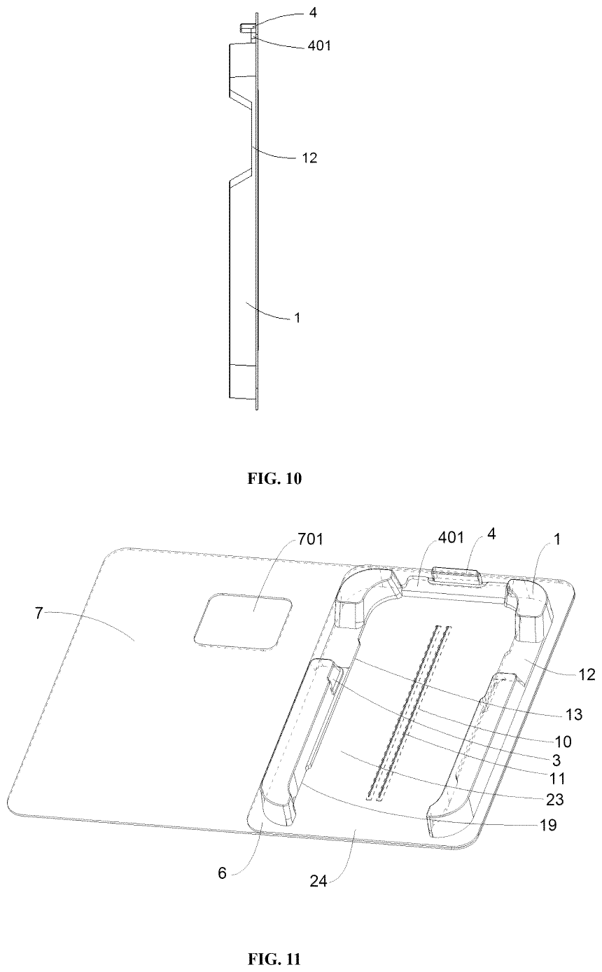

As shown in the embodiments of FIGS. 9-10, a second groove 24 is defined on an end of the positioning seat 1, and a positioning block 4 is arranged on the other end of the positioning seat 1, where a lifting portion 401 is arranged around the positioning block 4. The lifting portion 401 has a thickness of 2 mm and is configured to hold the tempered glass screen protector of the mobile phone. In addition, the position of the notch 12 in the embodiments may be slightly adjusted towards the positioning block 4, such that it is more convenient for the user to place the mobile phone in and take it out.

The embodiment shown in FIG. 11 differs from the embodiment shown in FIG. 8 in that a second groove 24 is defined on an end of the positioning seat 1, and a positioning block 4 is arranged on the other end of the positioning seat 1, where a lifting portion 401 is arranged around the positioning block 4. The lifting portion 401 has a thickness of 2 mm and is configured to hold the tempered glass screen protector of the mobile phone. In addition, the position of the notch 12 in the embodiment may be slightly adjusted towards the positioning block 4, such that it is more convenient for the user to place the mobile phone in and take it out. In addition, the difference from the embodiment shown in FIG. 2 is that the pressure block 9 on the side cover 7 may be replaced with an opening 701, the position of which is set facing the position of a camera of the mobile phone, and the opening 701 may be slightly larger than the camera. The opening 701 is configured to avoid the position of the camera when the side cover 7 covers the mobile phone.

The beneficial effect of the present disclosure is that by defining the profiling cavity in the positioning seat, the profiling cavity not only holds and protects the tempered glass film, but also positions the mobile phone to assist in applying the film, which reduces production and packaging costs, and further greatly reduces the difficulty of applying the film and greatly simplifies the operating process.

The above present disclosure is further described by way of specific embodiments, but it is to be understood that the specific description herein should not be interpreted as a limitation on the substance and scope of the present disclosure. Various modifications made to the above embodiments by those skilled in the art after reading the description fall within the scope of the present disclosure.

What is claimed is:

1. A packaging box for assisting in application of a tempered glass screen protector for a mobile phone, comprising: a first base plate;
wherein a positioning seat is arranged on the first base plate, and a profiling cavity is defined on the positioning seat; a side of the first base plate is arranged with a side cover that is flippable; an outer side of the side cover and the first base plate is sleeved with a side envelope.

2. The packaging box according to claim 1, wherein a side wall of the profiling cavity defines a first clearance.

3. The packaging box according to claim 2, wherein a first groove is defined on the positioning seat on an end of the profiling cavity, and a second groove is defined on the positioning seat on an opposite end of the cavity; a positioning block is arranged on the first groove, and a side of the positioning block is arranged with an adhesive sheet.

4. The packaging box according to claim 3, wherein each of two symmetrical inner walls of the profiling cavity is arranged with a step, and a second clearance is defined on an end of the step close to the positioning block.

5. The packaging box according to claim 4, wherein a limiting slot is defined on the step.

6. The packaging box according to claim 1, wherein the side envelope comprises a second base plate, and each of two opposite ends of the second base plate is arranged with a first side plate that is foldable; a side of the second base plate is arranged with a second side plate that is foldable; a side of the first side plate is arranged with a wing plate that is foldable; a slot is defined between the first side plate and the wing plate; a side of the second side plate is arranged with a cover plate that is foldable, and each of two opposite ends of the cover plate is arranged with a plug-in tab configured to match with the slot.

7. The packaging box according to claim 1, wherein the side envelope comprises a second base plate, and each of two opposite ends of the second base plate is arranged with a first side plate that is foldable; a side of the second base plate is arranged with a second side plate that is foldable; an opposite side of the second base plate is arranged with a third side plate; a side of the first side plate is arranged with a wing plate that is foldable; a side of the third side plate is arranged with a first outer wing plate; a slot is defined between the first side plate and the wing plate; a side of the second side plate is connected to a cover plate that is foldable; each of two opposite ends of the cover plate is arranged with a plug-in tab configured to match with the slot; a side of the cover plate is arranged with a fourth side plate that is foldable, and a side of the fourth side plate is arranged with a second outer wing plate that is foldable.

8. The packaging box according to claim 6, wherein a cutout is defined on each of the second base plate and the cover plate.

9. The packaging box according to claim 1, wherein a pressure block is arranged in the middle of the side cover; or, an opening is defined on the side cover.

10. The packaging box according to claim 1, wherein a positioning slot is vertically defined in the profiling cavity, and a heightening strip is arranged in the positioning slot.

11. The packaging box according to claim 1, wherein a notch is defined on the positioning seat on each of both opposite sides of the profiling cavity.

12. The packaging box according to claim 1, wherein an end of the positioning seat defines a second groove, and an opposite end of the positioning seat is arranged with a positioning block; a lifting portion is arranged around a periphery of the positioning block.
